(19) United States
(12) Patent Application Publication
(10) Pub. No.: US 2010/0170725 A1
(43) Pub. Date: Jul. 8, 2010

(54) TOUCH SURFACE AND SYSTEM AND METHOD OF DETECTING TOUCH INPUT

(75) Inventors: Amy Mei Sze Au-Yeung, Hong Kong (HK); I-Ting Tsai, Hong Kong (HK); Shou Lung Chen, Hong Kong (HK); Chen Jung Tsai, Hong Kong (HK)

Correspondence Address: VENABLE LLP, P.O. BOX 34385, WASHINGTON, DC, 20043-9998, US

(73) Assignee: Hong Kong Applied Science and Technology Research Institute, Hong Kong (CN)

(21) Appl. No.: 12/349,308

(22) Filed: Jan. 6, 2009

(51) Int. Cl. G06F 3/042

(52) U.S. Cl. 178/18.09

(57) ABSTRACT

A system and method for touch detection and a touch-responsive surface are provided. According to one embodiment, a “virtual” touch-sensitive surface in is provided in that a plurality of transmitter-sensor devices receive and calculate a touch by detecting position and movement on a touch surface. The touch surface includes a planar surface; a first transmitter-sensor device located at a first position proximate to the planar surface and a second transmitter-sensor device located at a second position proximate to the planar surface, wherein each of the transmitter-sensors includes a light beam emitter and a scanning micromirror to reflect the light beam across the planar surface. A processing unit is in operable communication with the first transmitter-sensor device and the second transmitter-sensor device, and the processing unit is configured to calculate the position of a touch on the planar surface based on one or more times of refection of the light beams.

### FIELD OF THE INVENTION

The present invention relates to a touch surface, and more particularly, to a system and method of detecting touch input.

### BACKGROUND OF THE INVENTION

A large number of products have begun incorporating touch-sensitive display screens or display panels such as mobile phones, electronic games, and other portable devices. The touch sensitive screens presently use one of a number of available technologies, including resistive panels that include a plurality of sensors in a matrix pattern to detect pressure and capacitive-type panels that include a plurality of electrically active layers to detect contact. These touch screens each have a number of limitations, including limited quality and high costs when large panels are desired. Accordingly, there is a need for a touch surface and a system and method of detecting touch input that addresses these and other shortcomings.

### SUMMARY OF THE INVENTION

According to one embodiment of the present invention, a touch surface is disclosed. The touch surface includes a planar surface; a first transmitter-sensor device at a first position proximate to the planar surface, wherein the first transmitter-sensor device includes a first light beam emitter configured to emit a first light beam, a first movable surface to reflect the first light beam across the planar surface, and a first light sensor configured to detect a reflection of the first light beam; a second transmitter-sensor device at a second position proximate to the planar surface, wherein the second transmitter-sensor device includes a second light beam emitter configured to emit a second light beam, a second movable surface to reflect the second light beam across the planar surface, and a second light sensor configured to detect a reflection of the second light beam; a processing unit in operable communication with the first transmitter-sensor device and the second transmitter-sensor device, wherein the processing unit is configured to calculate the position of a touch on the planar surface based on a time of the refection of the first beam and the time of the reflection of the second beam.

According to one embodiment of the present invention, a method of touch detection to detect a position on a planar surface a touch surface is disclosed. The method includes providing a planar surface; emitting a first light beam from a first position on the planar surface; reflecting the first light beam across the planar surface generally parallel to the planar surface, wherein the first light beam is reflected at a plurality of predetermined angles each corresponding to a plurality of predetermined times; emitting a second light beam from a second position on the planar surface; reflecting the second light beam across the planar surface generally parallel to the planar surface, wherein the second light beam is reflected at a plurality of predetermined angles each corresponding to a plurality of predetermined times; detecting a reflection of at least one of the first light beam and the second light beam at a time t1; identifying a first angle of the reflection of the first light beam a time t1; identifying a second angle of the reflection of the second light beam at time t1; and calculating a touch position based the first angle and the second angle.

According to one embodiment of the present invention, a touch surface is disclosed. The touch surface includes a planar surface; means for detecting a contact with the planar surface; means for determining a first angle of the contact with the planar surface; means for determining a second angle of the contact with the planar surface; processing means for calculating x and y position coordinates using the first angle of the contact and the second angle of the contact.

Still other embodiments of the present invention will become readily apparent to those skilled in the art from the following detailed description, wherein embodiments of the invention are described by way of illustration. As will be realized, the invention is capable of other and different embodiments and its several details are capable of modifications in various respects, all without departing from the spirit and the scope of the present invention.

### BRIEF DESCRIPTION OF THE DRAWINGS

FIG. 1 is a schematic diagram of a touch surface illustrating the operation of a touch surface and touch detection system, in accordance with one embodiment of the present invention.

FIG. 2 is a block diagram illustrating an example control system of the touch detection system, in accordance with an embodiment of the present invention.

FIG. 3 is a perspective view schematic diagram illustrating a first step of a position calculation, in accordance with an embodiment of the present invention.

FIG. 4 is a front view of a schematic diagram illustrating a second step of a position calculation, in accordance with an embodiment of the present invention.

### DETAILED DESCRIPTION

In the following description, reference is made to the accompanying drawings where, by way of illustration, specific embodiments of the invention are shown. It is to be understood that other embodiments may be used as structural and other changes may be made without departing from the scope of the present invention. Also, the various embodiments and aspects from each of the various embodiments may be used in any suitable combinations. Accordingly, the drawings and detailed description are to be regarded as illustrative in nature and not as restrictive.

Generally, embodiments of the present invention are directed to a touch surface and a method and system of detecting touch and movement on the touch surface. Detection is performed using optical transmitters and optical sensors. Embodiments of the present invention may be used on any generally flat surface that requires touch responsiveness to be incorporated such as, for example, electronic displays, touch screens, and mobile devices. The touch surface may be a real surface or a virtual surface created in space, such as in the case of a projection system. Embodiments of the present invention provide a “virtual” touch-sensitive surface in that a plurality of transmitter-sensor devices determines a “touch” on the surface by detecting position and movement, and therefore embodiments of the present invention do not directly detect pressure or physical contact on the surface.

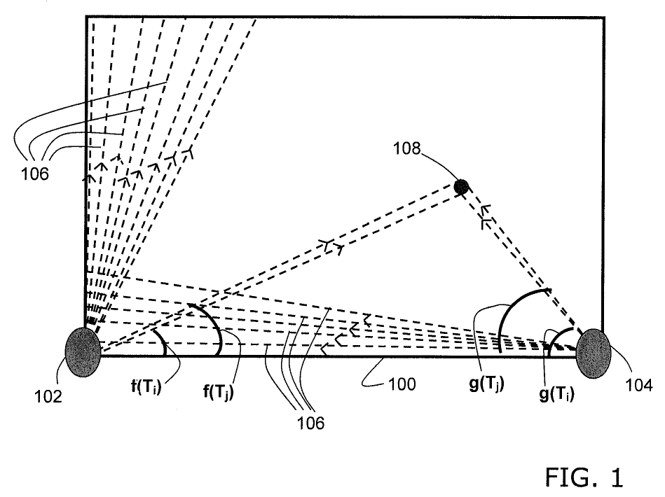

Referring now to the figures, FIG. 1 is a schematic diagram of a touch panel illustrating the operation of the touch surface and touch detection system, in accordance with one embodiment of the present invention. A touch surface 100 is shown as a generally rectangular area. The touch surface 100 may be a display panel or display screen or a part of a display panel or screen. A touch 108 is illustrated as a round dot, indicating a point in the touch surface that is touched with a user's figure or other device, such as a pen, stylus, or other object having a sufficiently succinct size to indicate a touch on a screen or display. A first transmitter-sensor device 102 is positioned at a first corner of the touch surface 100 and a second transmitter-sensor device 104 is positioned at a second corner of the touch surface 100. In the illustrated schematic diagram, the first transmitter-sensor device 102 is positioned in the lower-left corner and the second transmitter-sensor device 104 is positioned in the lower-right corner of the touch surface. However, the two transmitter-sensor devices may be positioned in any two corners of the surface 100. The transmitter-sensors also need not be positioned in the corners of the touch surface 100. While two transmitter-sensor devices are sufficient for the operation of the system, two or more transmitter-sensor devices used along the edges of the surface, or in other locations, may be used with the appropriate calculations, in accordance with the teachings of the present invention.

Each of the transmitter-sensor devices 102, 104 includes a light-beam emitter to emit a light beam, a movable, reflective surface to reflect the emitted light beam across the touch surface 100 generally parallel to the touch surface 100, and a light sensor to detect any reflection of the emitted light beam, which is cause by user touch of the surface. For example, according to one embodiment of the invention, the light beam emitter in each of the transmitter-sensor devices 102, 104 is a laser emitting device, the movable, reflective surface is a scanning micromirror, and the light sensor is a laser sensor for detecting reflection of the laser beam emitted from the laser emitting device. The laser emitting device may be a laser diode and the laser is directed to the scanning micromirror. The scanning micromirror reflects the laser across the touch surface 100 over a 90 degree range. While a 90 degree range allows the laser to be transmitted across the entire area of the touch surface 100, other ranges may be used as required by the particular implementation and 90 degrees is only one example of a suitable transmission range. This laser reflection is illustrated by a plurality of lines 106 shown emitted from the first transmitter-sensor device 102 and the second transmitter-sensor device 104. The scanning micromirror is, for example, made by MEMS (microelectromechanical systems) processing. However, other suitable devices may also be used.

One advantage of detecting the reflection of the touch is a reduced processing load on the system. Embodiments of the present invention do not need to continuously process repeated reflection in the absence of a touch to the screen. Instead, additional processing is required only when a reflection is detected. Additionally, in one embodiment, no frame or border of a fixed size is required for the operation of the transmitter-sensor devices. This allows flexibility in the surface size since the system may be configured to operate with different surface sizes. However, a boundary or border may also be used for certain specific applications where a predetermined touch screen area is required.

According to one embodiment, any suitable laser emitting device may be used. For some applications, a small size laser emitting device is desired, for example, if the touch screen and the device incorporating the touch screen are small or when portability or mobility is required. One example suitable laser emitting device is a laser diode. The specification of one suitable laser diode includes a visible wavelength, such as approximately 380˜800 nm, a physical size of 5 cc or less, an operating voltage of ˜2.7-3V, and power ≦100 mW. In one embodiment, the laser emitted from the first transmitter-sensor device 102 has a wavelength/frequency that is different from the wavelength/frequency of the laser emitted from the second transmitter-sensor device 104. One example scanning micromirror may include the following specifications: single-axial (1-D scanning); scanning angle >90 degrees; scanning frequency ≧2 kHz; and operating voltage <30V. According to another embodiment, a two-axis (2-D) micromirror may be used to also scan for movement in a direction perpendicular to the touch surface. The use of a micromirror eliminates the need for mechanical devices and permits the construction of a small transmitter-sensor device.

Generally, each of the transmitter-sensor devices 102, 104 rapidly emits a laser beam of a predetermined wavelength and uses the scanning micromirror to direct the laser across the surface 100 across 90 degrees of rotation. Each of the transmitter-sensor devices 102, 104 includes a sensor to detect a laser beam of particular wavelength. With two or more transmitter-sensor devices at two or more corners of the surface 100, the position of the touch 108 on the surface 100 can be calculated. The angle and time of the emitted laser beam are predetermined, thereby allowing touch detection by the laser to be converted into a position location.

According to one embodiment, the first and second transmitter-sensor devices 102, 104 operate simultaneously and/or synchronously in a plurality of different configurations. For example, in a first configuration, at each time t, both the first transmitter-sensor device 102 and the second transmitter-sensor device 104 emit a beam simultaneously. In a second configuration, the first transmitter-sensor device 102 and the second transmitter-sensor device 104 emit alternating beams, for example, as follows:

at time t=0, the first transmitter-sensor device 102 emits a beam;

at time t=1, the second transmitter-sensor device 104 emits a beam;

at time t=2, the first transmitter-sensor device 102 emits a beam;

at time t=3, the second transmitter-sensor device 104 emits a beam; . . . .

In a third configuration, each of the first and second transmitter-sensor devices 102, 104 alternate emitting a predetermined number of beams, for example, as follows:

From time t=0 to t=89, device 102 emits a beam at each time t;

From time t=90 to 179, device 104 emits a beam at each time t;

From time t=180 to t=269, device 102 emits a beam at each time t;

From time t=270 to 359, device 104 emits a beam at each time t; . . . .

In the above example, the transmitter-sensor devices alternate in groups of ninety (90) beams. However, this number may vary depending on the implementation considering such variables as, for example, the size of the screen and the speed of the processing unit being used. Therefore, a fewer or greater number of predetermined beams may be alternately used to sweep across all or part of the touch surface 100.

In the third configuration, a predetermined number of beams may be emitted in a sweep across the touch surface 100 from the first transmitter-sensor device 102, and then a predetermined number of beams may be emitted in a sweep across the touch surface 100 from the second transmitter-sensor device 104, alternating during use of the system.

According to one embodiment, the system is configured such that each of the first transmitter-sensor device 102 and the second transmitter-sensor device can emit the predetermined number of beams at a sufficiently fast speed so that user touch can be detected. For example, each of the transmitter-sensor devices 102, 104 scans across the surface at least once during the duration of time required for a typical user touch or action performed on the touch surface 100.

According to one embodiment, each of the transmitter-sensor devices 102, 104 may emit a single, generally uninterrupted light beam that is reflected across the touch surface 100 by the micromirror or other reflective surface. According to another embodiment, each of the transmitter-sensor devices 102, 104 may rapidly emit a plurality of successive beams, each reflected a predetermined angle according to an associated time cycle.

Upon touching the surface with a finger or other device, a sufficient amount of the laser is reflected by the finger or device. The reflected laser signals are detected by the laser sensor and since the laser beam is emitted at predetermined angle at a certain time, the angles can be determined as a function of time and are represented as f(Tᵢ), f(Tⱼ), g(Tᵢ), and g(Tⱼ), where Tᵢ and Tⱼ are two specific times.

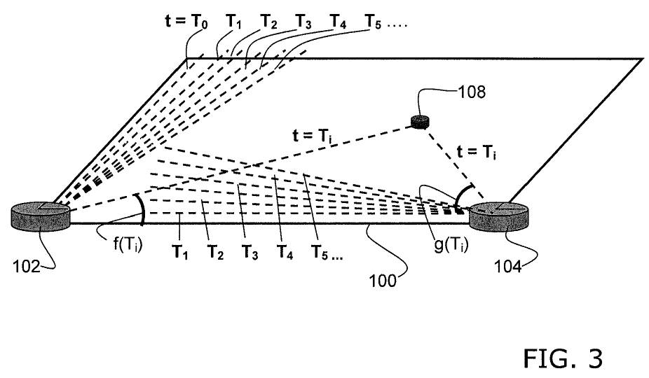

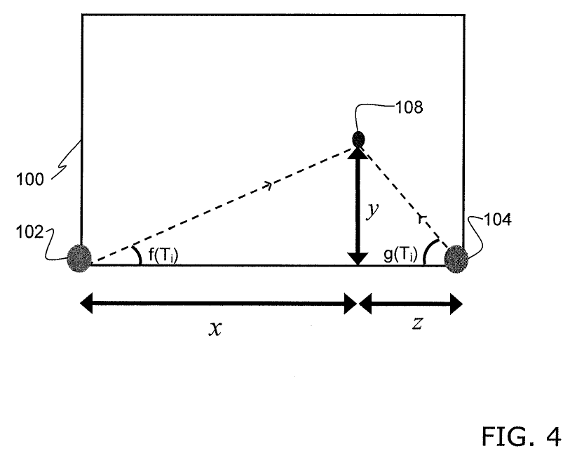

The location and size of the contact can be calculated using these four angles. Example calculations are provided and explained with reference to FIGS. 3 and 4.

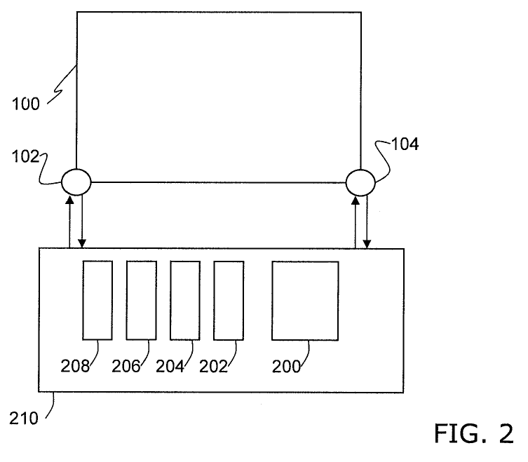

FIG. 2 is a block diagram illustrating the control system of the touch detection system, in accordance with one embodiment of the present invention. The first transmitter-sensor device 102 and the second transmitter-sensor device 104 of the touch surface 100 are controlled by a plurality of electronic drivers and processors. One example system may include a processing unit 200, a laser controller 202, a micromirror controller 204, one or more memories 206, a display controller 208. Each of the various controllers, drivers, and components may be incorporated on a control circuit 210. The necessary executable instructions may be stored in the one or more memories 206 and executed by the processing unit 200 and other components. The components and functions performed by these components may be combined into one or more devices and the example illustration should not be taken to necessarily be different components. The processing unit 200 is configured to process the information required for detecting contact and movement on the touch surface 100. Other suitable configurations of control systems may be used as the control system of FIG. 2 is provided as an example of control system components and functions.

FIG. 3 is a perspective view schematic diagram illustrating a first step of a position calculation, in accordance with one embodiment of the present invention. A plurality of dashed lines are used to illustrate the reflection of the light beam, or laser beam, emitted from each of the first and second transmitter-sensor devices 102, 104 at a plurality of predetermined angles, or directions, corresponding to a plurality of predetermined times (t=T₀, T₁, T₂ . . . Tₙ)

When a point of contact is made on the touch surface 100 at a time t, each of the light or laser beams are reflected by the object making contact. Each of the sensors then detects the reflection of the associate light or laser beam, and the angle of the emitted light or laser beams, ƒ(t) and g(t), can then be determined.

Functions ƒ(t) and g(t) yield the angles at which the lasers were reflected at any time t. These angles can both be determined since the movement of the scanning micromirror is configured such that the light or laser beam is directed at a specific angle at any given time t, with a cycle of scanning repeated. Accordingly, the angles ƒ(t) and g(t) can be determined as a function of time t.

FIG. 4 is a front view of a schematic diagram illustrating a second step of a position calculation, in accordance with one embodiment of the present invention. In the second step of the position calculation, position coordinates x and y are calculated at time t=Tᵢ as follows:

$$Let W = x + z$$

$$tan f ( {T}_{i} ) = \frac{y}{x}$$

$$tan g ( {T}_{i} ) = \frac{y}{z}$$

$$y = x tan f ( {T}_{i} ) = z tan g ( {T}_{i} ) = ( W - x ) tan g ( {T}_{i} )$$

$$x [ tan f ( {T}_{i} ) + tan g ( {T}_{i} ) ] = W tan g ( {T}_{i} )$$

$$x = \frac{W tan g ( {T}_{i} )}{tan f ( {T}_{i} ) + tan g ( {T}_{i} )}$$

$$y = x tan f ( {T}_{i} ) , ∴ \\ y = \frac{W tan f ( {T}_{i} ) tan g ( {T}_{i} )}{tan f ( {T}_{i} ) + tan g ( {T}_{i} )} .$$

While the illustration shown in FIG. 1 shows two angles taken by each transmitter-sensor devices 102, 104, the calculations described with reference to FIGS. 3 and 4 calculate position based on one angle ƒ(t) and one angle g(t) at time t=Tᵢ. Therefore, the calculations shown in FIGS. 3 and 4 may be repeated for any number of different times, as necessary. As illustrated in FIG. 1, the use of two times, and therefore two different angles from each of the transmitter-sensors devices 102, 104, allows a calculation to be made of the approximate size of the touch 108, thereby allowing a more precise calculation of the touch position.

One advantage to embodiments of the present invention is the ability to have a re-sizeable touch-responsive surface or panel. Because the size information of the panel can be determined using the transmitter-senor devices, and then this size used in calculating touch positions, the transmitter-sensor devices and the touch detection system may be used on a wide variety of surfaces or panels. Embodiments of the present invention provide the additional advantage of simultaneously satisfying many requirements for touch-responsive surfaces, including working with large size panels, providing high clarity, and having relatively low cost.

While the invention has been particularly shown and described with reference to the illustrated embodiments, those skilled in the art will understand that changes in form and detail may be made without departing from the spirit and scope of the invention. For example, while certain types of example transmitters and sensors are described, other suitable transmitters and sensors may be used. Also, while specific equations for calculating position are provided, other calculations made based on these teachings may be used in the case where transmitter-sensor devices are positioned in different locations other than those shown in the example embodiments.

Accordingly, the above description is intended to provide example embodiments of the present invention, and the scope of the present invention is not to be limited by the specific examples provided.

What is claimed is:

1. A touch surface comprising:
a planar surface;
a first transmitter-sensor device at a first position proximate to the planar surface, wherein the first transmitter-sensor device includes a first light beam emitter configured to emit a first light beam, a first movable surface to reflect the first light beam across the planar surface, and a first light sensor configured to detect a reflection of the first light beam;
a second transmitter-sensor device at a second position proximate to the planar surface, wherein the second transmitter-sensor device includes a second light beam emitter configured to emit a second light beam, a second movable surface to reflect the second light beam across the planar surface, and a second light sensor configured to detect a reflection of the second light beam;
a processing unit in operable communication with the first transmitter-sensor device and the second transmitter-sensor device, wherein the processing unit is configured to calculate the position of a touch on the planar surface based on a time of the refection of the first beam and the time of the reflection of the second beam.

2. The touch surface of claim 1, wherein each of the first light beam emitter and the second light beam emitter is a laser diode.

3. The touch surface of claim 1, wherein each of the light beam emitter and the second light beam emitter is a light emitting diode.

4. The touch surface of claim 1, wherein the first light beam is a first laser having a first predetermined wavelength/frequency and the second light beam is a second laser having a second predetermined wavelength/frequency and the second light signal.

5. The touch surface of claim 1, wherein the movable surface is a scanning micromirror by MEMS processing.

6. The touch surface of claim 1, wherein the first light beam is reflected at a plurality of predetermined angles corresponding to a plurality of predetermined times and the second light beam is reflected at a plurality of predetermined angles corresponding to a plurality of predetermined times, and calculating the position of the touch on the planar surface includes identifying a first angle corresponding to the time of the reflection and identifying a second angle corresponding to the time of the reflection, wherein the first angle is an angle of the first beam at the time of the reflection and the second angle is an angle of the second beam at the time of the reflection, and using the first angle and the second angle to calculate x and y position coordinates.

7. The touch surface of claim 1, wherein the planar surface has predetermined dimensions, and wherein the processing unit is configured to calculate the dimensions of the planar surface.

8. The touch surface of claim 1, wherein the touch surface has a perimeter defining an area of the touch surface, and where the perimeter does not reflect the first and second light beam sufficiently to be registered by the first light sensor and the second light sensor.

9. The touch surface of claim 1, wherein the microprocessor is configured to emit the first light beam from the first light beam emitter and the second light beam from the second light beam emitter synchronously and simultaneously.

10. The touch surface of claim 9, wherein the microprocessor is further configured to reflect the light beam from the first light beam emitter rapidly across the touch surface and reflect the light beam from the second light beam emitter rapidly across the touch surface.

11. The touch surface of claim 1, wherein the planar surface is a virtual surface.

12. The touch surface of claim 1, wherein the first transmitter-sensor device is located at a first corner of the planar surface, and the second transmitter-sensor device is located at a second corner of the planar surface, the second corner diagonally across from the first corner.

13. A method of touch detection to detect a position on a planar surface, the method comprising:
providing a planar surface; emitting a first light beam from a first position on the planar surface;
reflecting the first light beam across the planar surface generally parallel to the planar surface, wherein the first light beam is reflected at a plurality of predetermined angles each corresponding to a plurality of predetermined times;
emitting a second light beam from a second position on the planar surface;
reflecting the second light beam across the planar surface generally parallel to the planar surface, wherein the second light beam is reflected at a plurality of predetermined angles each corresponding to a plurality of predetermined times;
detecting a reflection of at least one of the first light beam and the second light beam at a time t1;
identifying a first angle of the reflection of the first light beam a time t1;
identifying a second angle of the reflection of the second light beam at time t1; and
calculating a touch position based the first angle and the second angle.

14. The method of claim 13, further comprising:
detecting a reflection of at least one of the first light beam and the second light beam at a time t2;
identifying a first angle of the reflection of the first light beam a time t2;
identifying a second angle of the reflection of the second light beam at time t2; and
calculating a touch position based the first angle and the second angle.

15. The method of claim 13, further comprising dynamically calculating the dimensions of the planar surface.

16. The method of claim 13, wherein the first light beam is a first laser having a first predetermined wavelength/frequency and the second light beam is a second laser having a second predetermined wavelength/frequency and the second light signal.

17. A touch surface comprising:
a planar surface;
means for detecting a contact with the planar surface;
means for determining a first angle of the contact with the planar surface;
means for determining a second angle of the contact with the planar surface;
processing means for calculating x and y position coordinates using the first angle of the contact and the second angle of the contact.

18. The touch surface of claim 17, wherein means for detecting a contact with the planar surface includes optical means for transmitting an optical beam, reflective means for directing the optical beam across the planar surface, and sensor means for detecting a reflection of the optical beam.

19. The touch surface of claim 18, wherein means for determining a first angle of the contact with the planar surface and means for determining a second angle of the contact with the planar surface include associating a plurality of times with a plurality of predetermined angles.

20. The touch surface of claim 19, wherein the processing means is further configured for detecting the contact with the planar surface, determining the first angle of the contact with the planar surface, and determining the second angle of the contact with the planar surface.
